(19) United States
(12) Patent Application Publication
(10) Pub. No.: US 2004/0032924 A1
(43) Pub. Date: Feb. 19, 2004

(54) Fuel assembly inspection system (FAIS)

(76) Inventor: John Joseph Judge JR., Vernon, VT (US)

Correspondence Address: R.O.V. TECHNOLOGIES INC., 616 FRANKLIN ROAD, VERNON, VT, 05354, US

(21) Appl. No.: 10/218,493

(22) Filed: Aug. 15, 2002

(51) Int. Cl. G21C 19/00

(52) U.S. Cl. 376/268

(57) ABSTRACT

By the use of two robotic arms installed on the dryer/separator guide rods of a nuclear reactor and the two stud mounted cameras, in total called the FAIS, this invention can perform “real time” core verification, fuel orientation, fuel height seating and debris inspections and verification of proper fuel orientation without the use of the refuel bridge and by use of remote robotic techniques.

### CROSS REFERENCE TO RELATED APPLICATION

This application duplicates provisional application No. 60/273 309 filed Jul. 27, 2001, confirmation number 2899.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

During a BWR (Boiling Water Reactor) refueling outage, the reactor vessel is fueled with new and semi-spent fuel bundles. The fuel bundles must be orientated in a predisposed manner and placed into a predisposed grid opening within the reactor vessel. In addition, each fuel bundle must be independently verified after placement for the correct serial number, proper seating, proper orientation and lack of debris or damage. In the past, this operation was performed after all refueling was complete using cameras mounted to the refueling bridge or trolley. The event took between six and twelve hours, normally of critical path time.

The FAIS performs all the aforementioned activities during the refueling operation independently, usually completing within ten minutes of the last fuel bundle loading. In addition, the FAIS does not require the use of the refueling bridge other than for installation and removal of the equipment. Therefore, the time for core verification normally assigned for refueling bridge activities may now be used for other scheduled critical path activities.

### BRIEF SUMMARY OF THF INVENTION

Simple stated the FAIS consists of two reactor vessel flange stud mounted robotic camera devices and two reactor steam separator guide mounted robotic arm camera devices. The equipment is controlled and operated remotely via video/control consoles equipped with many diverse features. Features include the capability to teed additional remote monitors while providing the ability to video record and provide still photographs of all activities for permanent record.

### BRIEF DESCRIPTION OF THE SEVERAL VIEWS OF THE DRAWING

The attached drawings show the entire FAIS system. Each module is described below

FIG. 1 Spare Record Console—This console operates, monitors and records the pan, tilt, zoom and focus functions for the stud mount camera, Item 2.

FIG. 2 Two stud cameras rest on the reactor head studs and are used to view all fuel movements Item 2 is shown as a spare within the complete system.

FIG. 3 Monitor Console—The console is used for viewing what the FAIS arm camera views.

FIG. 4 Arm Control Console—This console controls the X, Y, Z, an θ movements of the FAIS arms and the zoom, focus functions of the arm mounted camera.

FIG. 5 Light Control Box—This box operates the lights on the FAIS arm. These controls are sometimes included in Item 4 above.

FIG. 6 Pendant Box—This box is used to remotely control the FAIS arm at a pre-established distance from the arm control console, Item 4 above. It has all the same features described in Item 4 above.

FIG. 7 Monitor—Placed on the refuel bridge, the fuel handling personnel can obtain a view of any of the FAIS cameras.

FIG. 8 Wireless Video Receiver—This is used to receive the signal from the video distribution console to feed the monitor on the refuel bridge.

FIG. 9 Wireless Audio Headset—Used for communications

FIG. 10 Audio/Field Review Console—Used for viewing, recording and audio headset controls.

FIG. 11 Wireless Video Transmitter—Used for transmitting the video signal from the FAIS to the refuel bridge.

FIG. 12 Stud Camera—In and out connections to Item 14 distribution box.

FIG. 13 Camera Record Console—This console operates and monitors the tilt zoom and focus function of the FAIS stud (Item 15) mounted cameras.

FIG. 14 Video Distribution Console—Used to transmit any video signal to any prescribed location

FIG. 15 Same as Item 2.

FIG. 16 FAIS Arm—Installed in the reactor vessel onto the guide rod and rests on the steam dam. Functions include boom up and down, turret right and left, mid tilt up and down and camera pan.

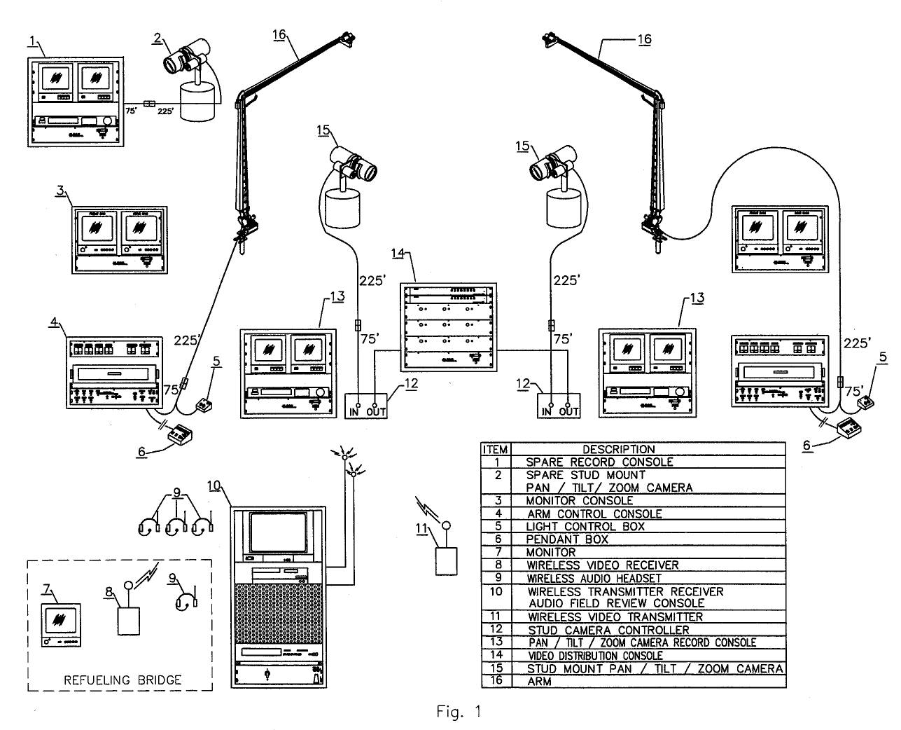

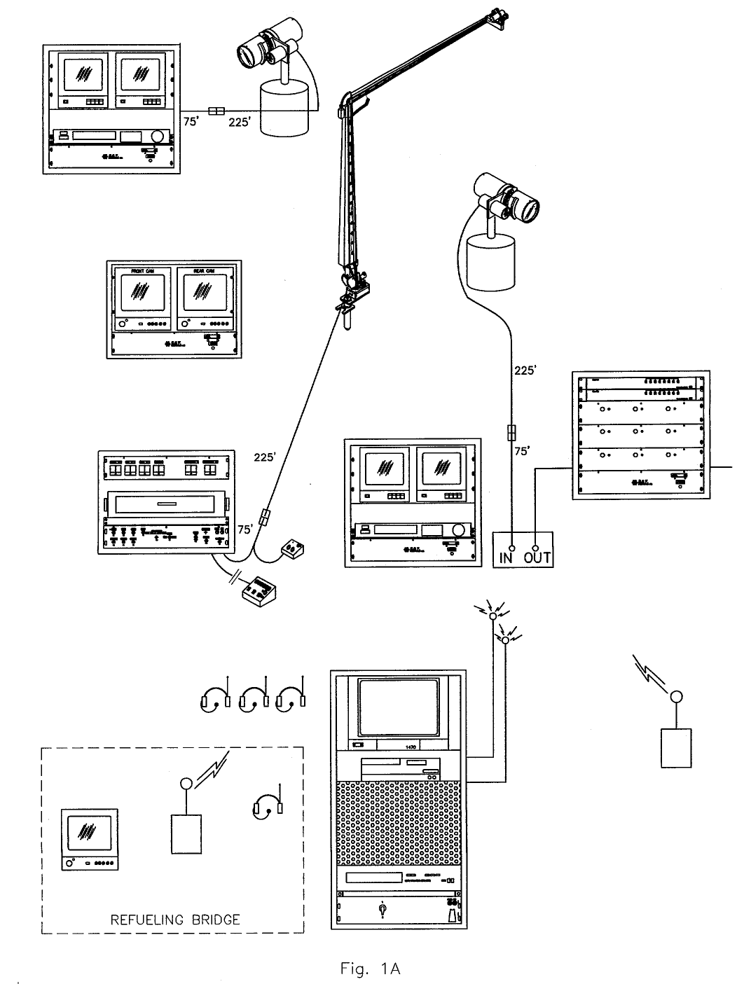

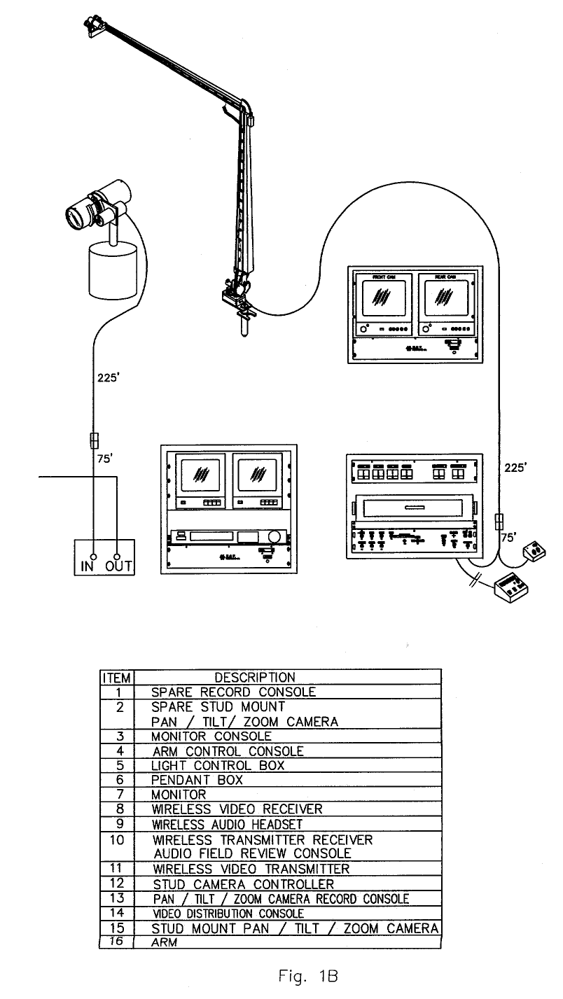

### DETAILED DESCRIPTION OF THE INVENTION

The robotic arms, cameras, lights, cabling, monitors, recorders, control consoles, wireless and signal equipment make up the system entitled the Fuel Assembly Inspection System (FAIS). The robotic arm assemblies are lowered into the vessel after flood-up, mount into the steam separator guide pin holes and rest on the shroud flange or steam dam, depending on each unique vessel configuration. Each arm is capable of finite X, Y, Z and Theta (θ) axis positioning of a high resolution 24× color zoom camera with related, “independently controlled”, high power underwater lighting. The images obtained are fed through the specialized control cable to a remotely located control station. The primary function of these cameras is to obtain detailed views of fuel bundle orientation, seating and serial number verification in “real time”, i.e. core verification is normally completed within 10 minutes of the last fuel bundle insertion, with dose savings well above 100 mrem.

The stud mounted cameras located on the reactor vessel head studs (180 degrees apart) are placed into position prior to flood up. The full pan and tilt capability of the 24× high resolution color zoom camera and related independently controlled high power underwater lighting provide detailed viewing of all in-vessel refueling, inspection and tooling activities. During the actual fuel load, these cameras are used to assist in verifying orientation and assist in fuel bundle to cell insertion. The images obtained are fed through the specialized control cable to the remotely located control station and by wireless to the refuel bridge in order to aid in quick and accurate fuel bundle insertion.

The remote control station, generally housed in a “clean” area Kelly building or other suitable structure, consists of the control panel, related monitors and video recording/processing components required to support each robotic camera setup. A video switching console and wireless transmitter allows for video feeds to be sent to additional locations such as the refueling bridge, Outage Control Center, Radiation Protection Center or any designated location desiring management overview capability.

It should be noted that incorporating the robotic systems detailed above does not require the use of the refuel bridge other than for initial installation and removal. Therefore, the time for core verification and fuel pool audits normally assigned for refuel bridge activities may now be used for other scheduled activities, i.e steam dryer and separator preparations, IVVI, etc.

1. I claim the FAIS is the only system which can perform “real time” core verification, fuel orientation, fuel height seating and debris inspections and verification of proper fuel orientation without the use of the refuel bridge and by the use of remote robotic techniques.
